(19) United States
(12) Patent Application Publication
(10) Pub. No.: US 2009/0014418 A1
(43) Pub. Date: Jan. 15, 2009

(54) Electrical Switching Device with Potential Control

(75) Inventors: Heiko Jahn, Hemsbach (DE); Christian Wallner, Berlin (DE)

Correspondence Address: LERNER GREENBERG STEMER LLP, P O BOX 2480, HOLLYWOOD, FL, 33022-2480, US

(73) Assignee: SIEMENS AKTIENGESELLSCHAFT, Munchen (DE)

(21) Appl. No.: 12/162,276

(22) PCT Filed: Jan. 3, 2007
(86) PCT No.: PCT/EP2007/050043

§ 371 Date: Jul. 25, 2008

(30) Foreign Application Priority Data
Jan. 26, 2006 (DE) 10 2006 004 811.3

(51) Int. Cl. H01H 33/16

(52) U.S. Cl. 218/144

(57) ABSTRACT

An electrical switching device with potential control has at least one interrupter unit. The interrupter unit has an electrical switching point and an electrical capacitance with respect to the electrical grounding. Conventionally, electrical switching devices, such as circuit breakers for high-voltage installations, for example, with so-called control capacitors, which are connected in parallel with the switching point, are used for making the voltage uniform across a plurality of interrupter units of an electrical switching device. As a result, a virtually uniform voltage load on all the interrupter units of the electrical switching device is ensured. The idea here is to use resistive and/or inductive components for making the voltage uniform across the electrical switching device instead of or in addition to the control capacitors used.

The invention relates to an electrical switching device, having at least one interrupter unit for interrupting an existing electrical connection, with the interrupter unit having an electrical capacitance with respect to the electrical ground.

The invention also relates to the use of the electrical switching device according to the invention for DC or AC voltage grid systems.

Electrical switching devices are essential components of an electrical supply network. Electrical switching devices for the purposes of the present invention are switching devices for high-voltage applications at voltages of more than 1 kV.

The major component of an electrical switching device—in particular for high-voltage installations—is normally an interrupter unit, comprising a switching chamber with an electrical switch point which is located in the switching chamber. When the electrical switch point is open, the switch point of the electrical switching device acts like a capacitor with the electrical capacitance C_{K}. Furthermore, an electrical capacitance C_{E} is formed between the live electrical switching device and the electrical ground.

Particularly in the case of electrical switching devices, such as circuit breakers, for the high-voltage range, the high switched voltages in an electrical switching device mean that a plurality of interrupter units are arranged in series. When the electrical switching device is in the disconnected state, non-uniform voltage distributions occur in this case between the individual interrupter units and between the interrupter units and electrical ground, and in some cases these can lead to destruction of the voltage-loaded interrupter unit, and therefore of the electrical switching device.

For this reason, so-called control capacitors are connected in parallel with the electrical switch point of each interrupter unit, and are used to form a virtually uniformly distributed voltage throughout the electrical switching device. The use of a control capacitor for each interrupter unit results in virtually identical voltage loads on the individual interrupter units in the electrical switching device. When an AC voltage is applied, these control capacitors lead to virtually complete galvanic isolation between the individual interrupter units in the disconnected state, and they are therefore used as standard in high-voltage circuit breakers.

However, the use of control capacitors in electrical switching devices represents a considerable cost factor. Furthermore, the additional control capacitors produce mechanical loads within the interrupter units, and these can lead to destruction of the electrical switching device, in particular when severe oscillations occur, as in the case of an earthquake or a storm. In addition, during grid operation damaging resonances of the voltage amplitudes within the electrical switching device or even within the entire electrical supply grid system can occur in conjunction with the capacitances and with other inductances that are present in the voltage grid system, for example transformers or inductors.

The document DE 199 58 646 C2 discloses a hybrid circuit breaker having a vacuum interrupter chamber in the form of a quenching chamber and with a conductive coating. A second switching chamber which is provided does not contain any conductive coating. The working range of the electrical resistance, produced by the conductive coating, in the hybrid circuit breaker is less than 500 kΩ. The aim of the coating in the hybrid circuit breaker is unequal control of the electrical voltage potential across two different types of switching chambers, with the purpose of avoiding restriking of the electrical switch during disconnection processes.

Furthermore, Ullrich, H., “Aging and Characterization of Semiconducting Glazes”, Gothenburg, Sweden, Chalmers University of Technology, School of Electrical and Computer Engineering, May 2004, ISBN 91-7291-432-7 proposes inductive glazing, for example glazing with SnO/SbₓO_{y} additives, in order to provide control for an electrical voltage potential on porcelain insulators. In the document cited above, the glazing is disclosed exclusively for this glazing being used on the outside of an insulating porcelain body.

Furthermore, the document IPCOM000125205D on the internet page “www.ip.com” describes a plastic composite insulator with an integrated capacitance. A capacitor is applied to the inner wall of a switching chamber of a circuit breaker, by means of a first coating, subsequent application of an insulation matrix and subsequent application of a second capacitor plate with a final plastic matrix as an insulation and reinforcing material. Further non-capacitive electrical

components used as voltage dividers are not disclosed in the document cited above.

The object of the present invention is therefore to avoid the disadvantages mentioned above in the prior art and to provide an electrical switching device which can be manufactured at low cost.

This object is achieved by the features specified in patent claim 1.

According to the invention, a non-capacitive electrical component with a resistive and/or inductive effect is connected in parallel with the electrical switch point, in order to smooth out the voltage distribution throughout the electrical switching device. Despite the use of no control capacitor at all and of an electrical capacitance connected thereto in parallel with the electrical switch point within the interrupter unit, a uniform voltage distribution is achieved throughout the electrical switching device.

In one advantageous refinement, the electrical switching device has at least two interrupter units, with in each case one electrical component, which has a resistive and/or inductive effect, being connected in parallel with each electrical switch point. This not only ensures that the voltages are made uniform throughout an interrupter unit but also that the voltages are made uniform over two interrupter units, and therefore throughout the electrical switching device.

In this case, the electrical component with the resistive and/or inductive effect may also be connected as a combination of a resistance and an electrical component with an inductive effect,

and may be used in parallel with the electrical switch point, for voltage splitting. The abovementioned examples for these disclosed non-capacitive electrical components should not be regarded as restrictive, and therefore also cover surge arresters.

In one preferred refinement of the invention, the interrupter unit is a switching chamber with a switch point, with the switching chamber having a poorly conductive coating. This coating acts as an electrical resistance which is arranged in parallel with the electrical switch point that is arranged within the switching chamber. The conductive coating is advantageously applied to the inner walls of the switching chamber. The conductive coating contains conductive varnishes, conductive plastics, for example plastics filled with conductive carbon black, or intrinsically conductive plastics, such as doped polyacetylene or polypyrrol. The conductive coating may likewise contain conductive glazings, such as glazings with SnO/SbₓO_{y} additives. The conductive coating is advantageously applied from the inside to the inner walls of the switching chamber, in particular by being painted and/or sprayed on and/or applied by means of a dipping process.

In one advantageous refinement of the invention, an insulating support is used to hold at least one interrupter unit, with the support likewise being coated from the inside with a conductive coating. The adjacent interrupter units may assume any angle with respect to one another. The resultant heat losses caused by the current flow through the coating on the support can be used for deliberate heating of the entire electrical switching device in order, for example, to prevent SF₆ gas becoming liquid at low temperatures.

The value of the resistance R_{S} connected in parallel with the electrical switch point should be chosen such that the resistance of the electrical component which has a resistive and/or inductive effect and is connected in parallel with the electrical switch point is chosen in accordance with the following formula for an electrical switching device having at least one first and one adjacent second interrupter unit for AC voltage such that the quotient of the voltage U across the first interrupter unit with respect to the total voltage U_{TOT} across the first and second interrupter units results approximately in the value 0.5:

$$\frac{U}{Utot} = \sqrt{\frac{1 + {ω}^{2} * {R}_{S}^{2} * {C}_{K}^{2} + 2 {ω}^{2} * {R}_{S}^{2} * {C}_{K} * {C}_{E} + {ω}^{2} * {R}_{S}^{2} * {C}_{E}^{2}}{4 {ω}^{2} * {R}_{S}^{2} * {C}_{K}^{2} + 4 {ω}^{2} * {R}_{S}^{2} * {C}_{K} * {C}_{E} + {ω}^{2} * {R}_{S}^{2} * {C}_{E}^{2} + 4}}$$

The parameter C_{K} represents the electrical capacitance of the first interrupter unit when the switch point is open, and C_{E} represents the electrical capacitance of the first and second interrupter units with respect to the electrical ground. The resistances in the two switching chambers are in this case the same and are chosen such that approximately 50% of the applied total voltage U_{TOT} is dropped across the respective interrupter unit for each switching chamber.

In an electrical switching device with more than two interrupter units, the interrupter unit which is referred to as the first interrupter unit can always be considered with respect to the adjacent, neighboring second interrupter unit. The voltage which is applied to these two interrupter units is based on the applied total voltage U_{TOT}. For example, for an electrical switching device with four interrupter units, the resistance R_{S} for the first and second interrupter units can be calculated in a first step.

The previously second interrupter unit is then defined as the first interrupter unit in a second step, and the third interrupter unit is regarded as the second interrupter unit. In this case, the voltage U_{TOT} is the voltage applied across the second and third interrupter unit.

When using an electrical component with a non-resistive effect, the reactance of the electrical component with an inductive effect is used as the impedance R_{S} to be calculated, analogously to the above formula.

In one advantageous refinement, the electrical switching device is a circuit breaker, in particular for high-voltage installations.

The electrical switching device according to the invention is advantageously used in a DC or AC voltage grid system, in particular for high voltages.

Further advantageous refinements are specified in the dependent claims.

The invention will be explained in more detail with reference to the attached drawings, in which:

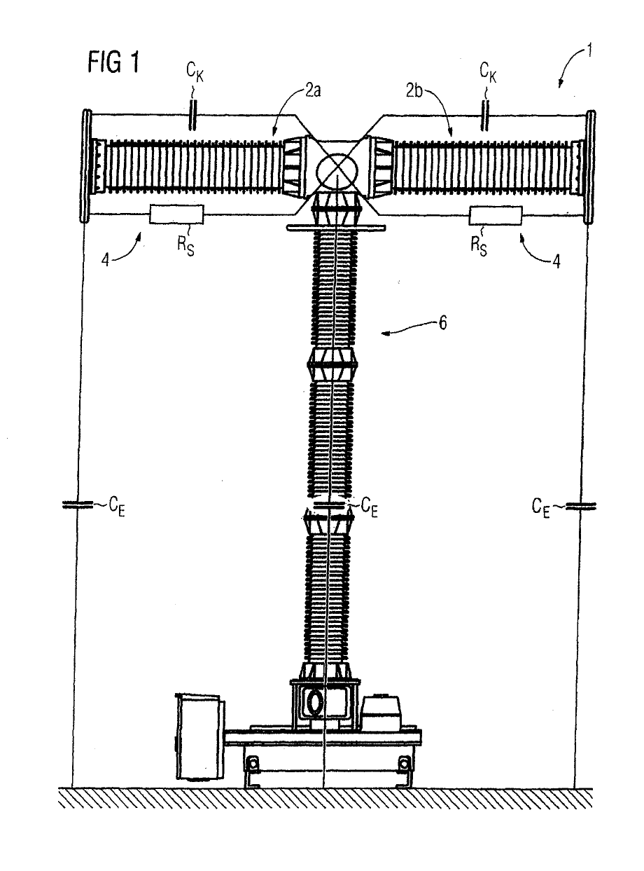

FIG. 1 shows a side view of the electrical switching device with two interrupter units, as well as the electrical equivalent circuit;

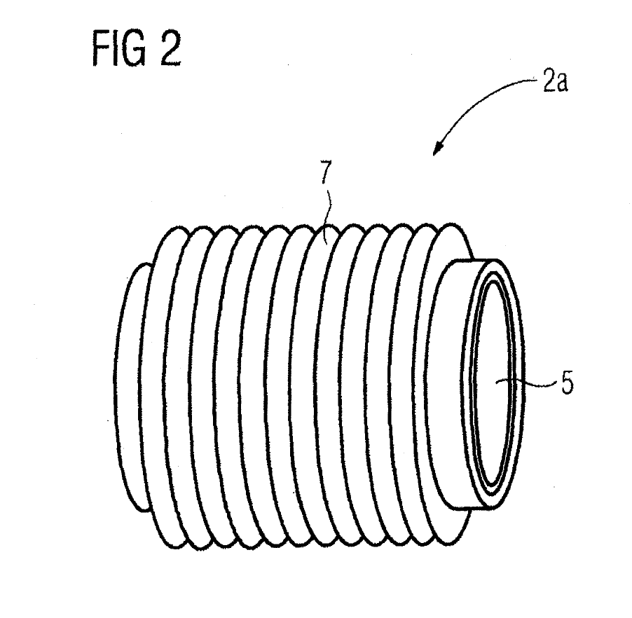

FIG. 2 shows a schematic side view of an interrupter unit with an internally arranged conductive coating in the switching chamber;

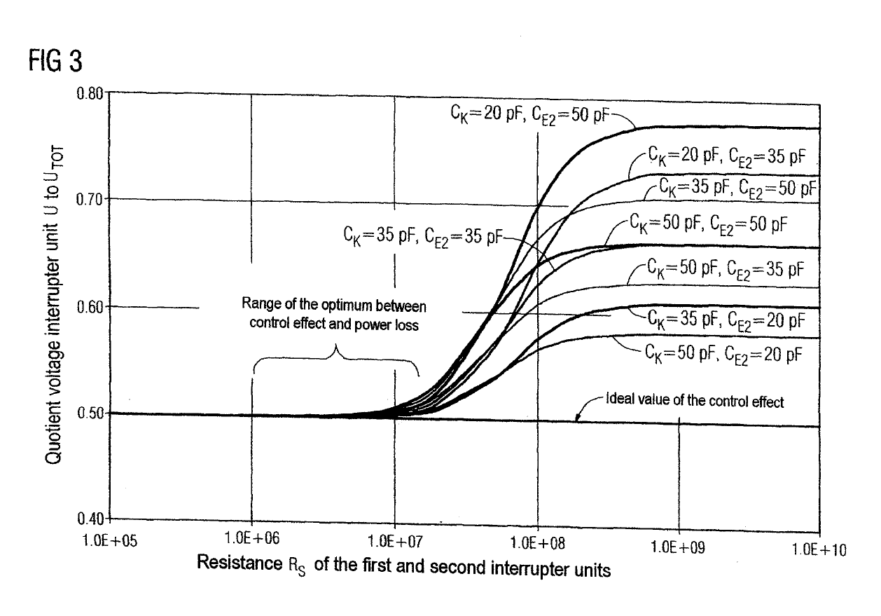

FIG. 3 shows an illustration of the voltage drop across an interrupter unit with respect to one control resistance R_{S} which is used for each interrupter unit, for different capacitances of the interrupter unit C_{K} and capacitances of the interrupter units with respect to electrical ground.

FIG. 1 shows a side view of the electrical switching device 1 with two interrupter units 2a, 2b, and the electrical equivalent circuit. The interrupter units 2a, 2b in the electrical switching device 1 are fixed by means of a support 6. The switch points 3 arranged in the interrupter units 2a, 2b are not illustrated in FIG. 1. The interrupter units 2a, 2b have an electrical capacitance C_{E} with respect to the electrical ground. As can be seen from the equivalent circuit of this electrical switching device 1 in FIG. 1, the electrical capacitance C_{K}, as the capacitance C_{K} of the interrupter unit 2a when the switch point 3 is open, is connected in parallel with a resistance R_{S}. The use of the resistance 4 as an electrical component with a resistive effect connected in parallel with the capacitance of the interruption unit 2a ensures that the voltage is distributed equally throughout the electrical switching device 1.

FIG. 2 shows a schematic side view of the interrupter unit 2a with an internally arranged conductive coating 5 on the switching chamber 7. The conductive coating 5 is used as the electrical component 4 with a resistive effect in parallel with the electrical switch point 3 (not shown) arranged in the switching chamber 7.

FIG. 3 shows the voltage drop across an interrupter unit with respect to a control resistance R_{S}

that is used for each interrupter unit, for different electrical capacitances. FIG. 3 shows that, if the interrupter unit 2a has an electrical capacitance C_{K} of 20 pF to 50 pF when the switch point 3 is open, and assuming that the capacitances of the interrupter unit 2a with respect to the electrical ground are 20 pF to 50 pF, there is a different profile of the quotients of the voltage U across the first interrupter unit 2a with respect to the total voltage U_{TOT} across the two interrupter units 2a, 2b. In a value range from 1,000 kΩ to approximately 10,000 kΩ of the resistance R_{S} of the first and second interrupter units 2a, 2b, the resistance R_{S} is optimally chosen such that there is a virtually equal voltage across the two interrupter units 2a, 2b. The abovementioned capacitances ensure an equal distribution of the applied total voltage across both interrupter units 2a, 2b.

1-10. (canceled)

11. An electrical switching device, comprising:
at least one interrupter unit having an electrical switch point and an electrical capacitance with respect to electrical ground; and
an electrical component having at least one of a resistive effect and an inductive effect connected in parallel with said electrical switch point for smoothing out a voltage distribution throughout the electrical switching device.

12. The electrical switching device according to claim 11, wherein said interrupter unit is one of a plurality of interrupter units, with in each case one said electrical component having at least one of said resistive effect and said inductive effect being connected in parallel with in each case one of said electrical switch points of a respective one of said interrupter units.

13. The electrical switching device according to claim 11, wherein said interrupter unit has a poorly conductive coating acting as an electrical resistance.

14. The electrical switching device according to claim 13, wherein said interrupter unit has a switching chamber with an inner wall, said conductive coating is applied to said inner wall of said switching chamber.

15. The electrical switching device according to claim 13, wherein said conductive coating contains at least one of conductive varnishes, conductive plastics and conductive glazings.

16. The electrical switching device according to claim 14, wherein said conductive coating is applied to said inner wall of said switching chamber by being one of being painted on, sprayed on, and applied by a dipping process.

17. The electrical switching device according to claim 11, further comprising an insulating support having a conductive coating and holding said interrupter unit.

18. The electrical switching device according to claim 12, wherein:
said plurality of interrupter units include at least one first interrupter unit and an adjacent second interrupter unit for an AC voltage;
said electrical component has a resistance R_{S} connected in parallel with said electrical switch point and chosen in accordance with the following formula for the electrical switching device having said first interrupter unit and said adjacent second interrupter unit for the AC voltage, such that a quotient of a voltage U across said first interrupter unit with respect to a total voltage U_{TOT} across said first and second interrupter units results approximately in a value 0.5:
$$\frac{U}{Utot} = \sqrt{\frac{1 + {ω}^{2} * {R}_{S}^{2} * {C}_{K}^{2} + 2 {ω}^{2} * {R}_{S}^{2} * {C}_{K} * {C}_{E} + {ω}^{2} * {R}_{S}^{2} * {C}_{E}^{2}}{4 {ω}^{2} * {R}_{S}^{2} * {C}_{K}^{2} + 4 {ω}^{2} * {R}_{S}^{2} * {C}_{K} * {C}_{E} + {ω}^{2} * {R}_{S}^{2} * {C}_{E}^{2} + 4}}$$
where C_{K} is said electrical capacitance of said first interrupter unit when said electrical switch point is open and C_{E} is an electrical capacitance of said first and second interrupter units with respect to the electrical ground.

19. The electrical switching device according to claim 11, wherein the electrical switching device is a circuit breaker.

20. A method of using an electrical switching device, which comprises the steps of:
providing the electrical switching device with at least one interrupter unit having an electrical switch point and an electrical capacitance with respect to electrical ground and an electrical component having at least one of a resistive effect and an inductive effect connected in parallel with the electrical switch point for smoothing out a voltage distribution throughout the electrical switching device; and
disposing the electrical switching device in a voltage grid system.

21. The method according to claim 20, which further comprises selecting the voltage grid system from the group consisting of a DC voltage grid system, an AC voltage grid system, and a high voltage grid system.
